(19) United States
(12) Patent Application Publication
(10) Pub. No.: US 2025/0139634 A1
(43) Pub. Date: May 1, 2025

(54) AUTOMATED RECOMMENDATIONS FOR HIERARCHICAL DATA STRUCTURES

(71) Applicant: INTUIT INC., Mountain View, CA (US)

(72) Inventors: Maria KISSA, Mountain View, CA (US); Nicholas Jeffrey HOH, Mountain View, CA (US); Jason WIRTH, Mountain View, CA (US)

(73) Assignee: INTUIT INC., Mountain View, CA (US)

(21) Appl. No.: 18/496,813

(22) Filed: Oct. 27, 2023

(51) Int. Cl. G06Q 20/40; G06Q 20/22

(52) U.S. Cl. CPC G06Q 20/405; G06Q 20/229

(57) ABSTRACT

Embodiments disclosed herein provide automated account recommendations for a hierarchical account structure. For an incoming transaction data record, a first language model is used to generate a recommended account name that is agnostic to the existing list of accounts. The recommended account name is appended to the existing list of accounts, which is consolidated to remove synonymous accounts. Additionally, a hierarchical relationship between the different accounts in the consolidated list of accounts is determined. A second language model is used to select an account name from the list of accounts. The selected account name along with any hierarchically related account name may be displayed to the user for selection.

### BACKGROUND

Computer applications support different aspects of modern electronic commerce. These aspects include different and varied functionality within the electronic commerce ecosystem such as providing user interfaces, performing background operations, displaying results, and the like. An example of such computer applications includes a transaction and account management application.

A computer application performing transaction and account management is inherently complex: it necessarily involves subroutines to ingest incoming transactions' data in real time and process and store the ingested transactions. Despite such complexity, challenges and technical shortcomings remain. For example, conventional computer applications are based on hard-coded subroutines that perform programmed operations. The programmed operations, however, are based on what was thought to be relevant during the designing and coding of the application—and are therefore limited by the foresight of the developer. On one hand, a computer application may not be complex enough to handle a more complex deployment environment. On the other hand, another computer application may be too complex—and therefore inefficient—for a relatively simple deployment environment. Because it is difficult to predict the complexity and the variety of transactions data during the design phase, transaction and account management computer applications may have complexity mismatch during deployment, which is undesirable.

One consequence of complexity mismatch is that a higher degree of user involvement is required during deployment. For example, the user may have to manually group, classify, and categorize transactions data. The deployed application may not support a new feature for the user, and the user may have to approximate the new feature using the existing functionality (i.e., there was not enough complexity in the deployed application). User involvement and manual processes are always inefficient and cumbersome and therefore undesirable.

As such, a significant improvement in computer applications providing transaction and account management is desired.

### SUMMARY

Embodiments disclosed herein solve the aforementioned technical problems and may provide other solutions as well. In one or more embodiments, an automated account management system supporting just-in-time complexity is provided. Using a first language model, the account management system may generate a recommended account name for a transaction without consulting an existing hierarchical data structure. The recommended account name is merged and consolidated with the existing hierarchical data structure. Hierarchical relationships may be determined within the consolidated existing hierarchical data structure. That is, parent-child taxonomy relationships (an example of the hierarchical relationships) between the account names are dynamically generated. Using a second language model, an account name is selected from the existing hierarchical data structure for the transaction and presented to the user. Because the use of the first language model is agnostic to the existing hierarchical data structure, the disclosed system is flexible and accommodates new types of transactions. Using the combination of the first and second language models provides just-in-time complexity to handle new or existing types of transactions.

### BRIEF DESCRIPTION OF THE DRAWINGS

FIG. 1 shows an example of a system configured for automated recommendations for a hierarchical data structure, based on the principles disclosed herein.

FIG. 2 is a functional diagram of an architecture for automated recommendations for a hierarchical data structure, based on the principles disclosed herein.

FIG. 3 shows a flow diagram of an example method of an automated account recommendation for a hierarchical account structure, based on the principles disclosed herein.

FIG. 4 shows an example graphical user interface (GUI) displaying an account name recommendation, based on the principles disclosed herein.

FIG. 5 shows a block diagram of an example computing device that implements various features and processes based on the principles disclosed herein.

### DETAILED DESCRIPTION OF SEVERAL EMBODIMENTS

Embodiments disclosed herein provide automated account recommendations for a hierarchical account data structure. For an incoming transaction data record, a first language model is used to generate a recommended account name agnostic to the existing list of accounts. The recommended account names is appended to the existing list of accounts, which is then consolidated to remove synonymous accounts. Additionally, hierarchical relationships between the different accounts in the consolidated list of accounts is determined. These hierarchical relationships may include parent-child taxonomy relationships between the account names. A second language model is used to select an account name from the list of accounts. The selected account name, along with any hierarchically related account name (e.g., a parent account name or a child account name), is therefore dynamically generated and displayed for selection.

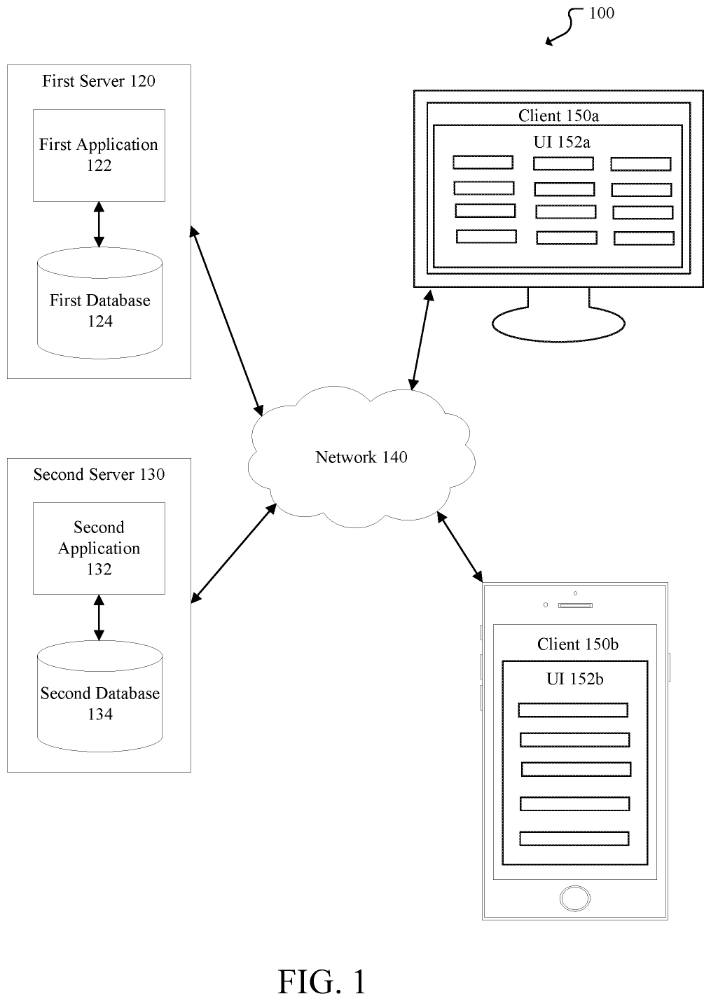

FIG. 1 shows an example of a system 100 configured for automated recommendations for a hierarchical data structure, based on the principles disclosed herein. It should be understood that the components of the system 100 shown in FIG. 1 and described herein are merely examples and systems with additional, alternative, or fewer number of components should be considered within the scope of this disclosure. In one or more embodiments, the hierarchical data structure comprises a chart of accounts as used in one or more transaction and account management applications. For example, the chart of accounts can be associated with QuickBooks® software sold by Intuit® of California. It should be appreciated that the disclosed principles are not limited to systems and applications having a chart of accounts and that the principles apply to any hierarchical data structure.

As shown, the system 100 comprises client devices 150a, 150b (collectively referred to herein as “client devices 150”), and first and second servers 120, 130 interconnected by a network 140. The first server 120 hosts a first server application 122 and a first database 124 and the second server 130 hosts a second server application 132 and a second database 134. The client devices 150a, 150b have user interfaces 152a, 152b, respectively, (collectively referred to herein as “user interfaces (UIs) 152”), which may be used to communicate with the server applications 122, 132 and using the network 140.

The server applications 122, 132 implement the various operations disclosed throughout this disclosure. For example, the server applications 122, 132 ingest transactions data and run different language models on the transactions data to perform account name recommendation, account name selection, account merging, account selection, and/or other operations. The language models may include, but are not limited to, large language models, generative artificial intelligence models, deep learning models, machine learning models, etc. The language models may be stored in the corresponding databases 124, 134. In one example, for a transaction and account management application, the databases 124, 134 may further store a user's chart of accounts. Additionally, the databases 124, 134 are used to store any kind of instructions and data to perform the operations described throughout this disclosure.

Communication between the different components of the system 100 is facilitated by one or more application programming interfaces (APIs). APIs of system 100 may be proprietary and or may include such APIs as AWS APIs or the like. The network 140 may be the Internet and or other public or private networks or combinations thereof. The network 140 therefore should be understood to include any type of circuit switching network, packet switching network, or a combination thereof. Non-limiting examples of the network 140 may include a local area network (LAN), metropolitan area network (MAN), wide area network (WAN), and the like.

Client devices 150 may include any device configured to present user interfaces (UIs) 152 and receive user inputs, e.g., user's response to recommended account names. The UIs 152 are generally graphical user interfaces (GUIs). For example, a user may use the UIs 152 to override recommended account names and enter a new account name instead. Additionally, the UIs 152 can show the chart of accounts generated by the server applications 122, 132 in any format. Therefore, the UIs 152 may provide any kind of information or prompt and/or receive user responses during an implementation of the embodiments disclosed throughout this disclosure.

First server 120, second server 130, first database 124, second database 134, and client devices 150 are each depicted as single devices for ease of illustration, but those of ordinary skill in the art will appreciate that first server 120, second server 130, first database 124, second database 134, and or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one) servers. In another example, a plurality of client devices 150 may communicate with first server 120 and or second server 130. A single user may have multiple client devices 150, and or there may be multiple users each having their own client devices 150.

Furthermore, it should be understood that the server applications 122, 132 running on the servers 120, 130, and the databases 124, 134 being hosted by the servers 120, 130 is just an example, and should not be considered limiting. Different portions of the server applications 122, 132 and, in one or more embodiments, the entirety of the server applications 122, 132 can be stored in the client devices 150. Similarly, different portions or even the entirety of the databases 124, 134 can be stored in the client devices 150. Therefore, the functionality described throughout this disclosure can be implemented at any portion of the system 100.

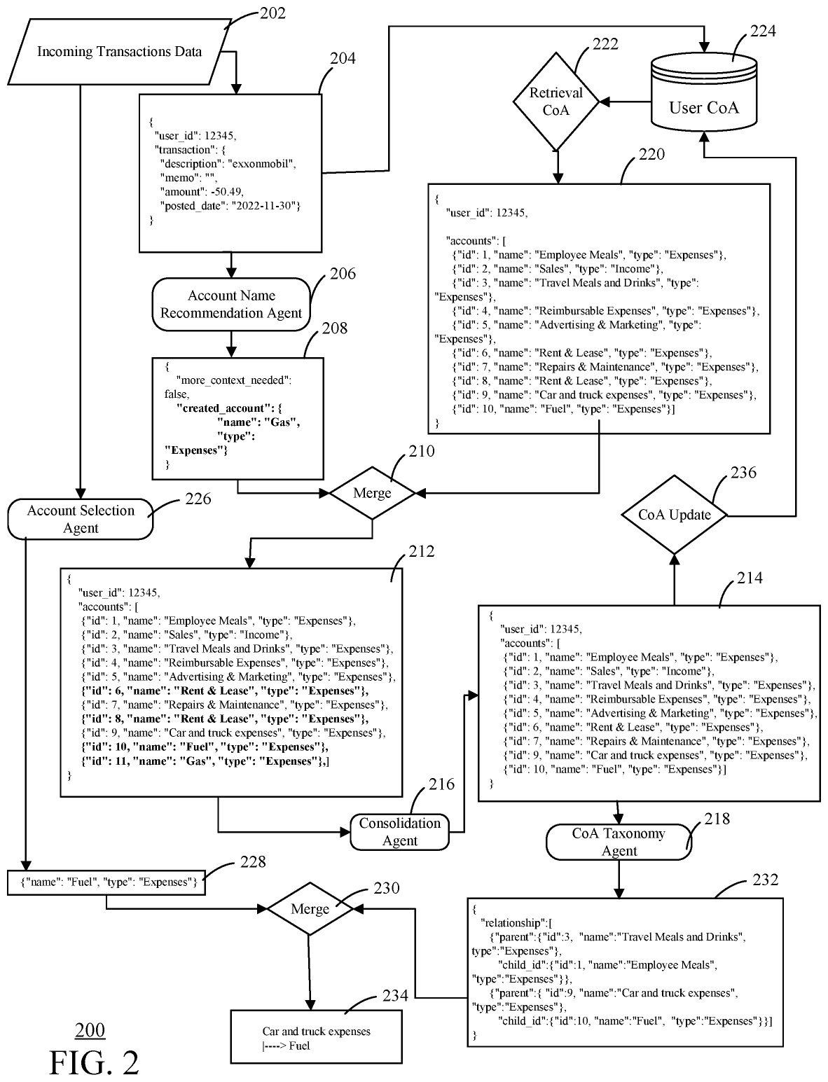

FIG. 2 is a functional diagram of an architecture 200 for automated recommendations for a hierarchical data structure, based on the principles disclosed herein. An example use case described herein is personalized and automated account suggestions for a hierarchical account structure such as the well-known chart of accounts. The architecture 200 may be implemented by any portion of the system 100 shown in FIG. 1 and described above. The architecture 200 and the flows between constituent components are just examples and should not be considered limiting.

As shown, the architecture 200 receives incoming transactions data 202. The transactions data 202 can be from any source, including but not limited to, banks, credit card companies, merchants, and/or the like. In an example use case, the architecture 200 is implemented by QuickBooks® software sold commercially by Intuit® of California. The software may be used for managing accounts and transactions. A goal of the architecture 200 is to automate account name generation for the incoming transactions data 202 such that the user does not have to manually generate account names and then categorize the incoming transactions data 202 to the generated account names.

The transactions data 202 includes a plurality of transactions, and an example transaction 204 (i.e., a data record of the transaction 204) is shown. As shown, the transaction 204 comprises a user_id field that corresponds to a numerical identifier (e.g., an account number) for a corresponding user. The transaction 204 comprises a description field that describes the transaction 204, e.g., as shown, the transaction 204 is associated with “exxonmobil”; a memo field for any additional information about the transaction 204, e.g., as shown, the memo field may be empty; an amount field specifying the transaction amount, e.g., as shown $50.49; and a posted_date field showing the date the transaction 204 was posted, e.g., as shown, Nov. 30, 2022. These are just some example fields for the transaction 204 and additional, alternative, and/or fewer number of fields should also be considered within the scope of this disclosure.

Based on the transactions data 202 (e.g., the fields within the plurality of transactions including the transaction 204), an account name recommendation agent 206 recommends an account name 208. The recommended account name 208 comprises a more_context_needed field, which indicates if additional information is needed for the account name recommendation. If this field is “false” (e.g., as shown), no additional information is needed; and if this field is “true,” additional information is needed. A recommended account name 208 is created when no additional information is needed. As shown, the recommended account name 208 has a name field with the value as “Gas” and a type field with the value “Expenses.” Typically, the name field indicates a specific name for an account, e.g., the shown “Gas” account, a “Sales” account, and the like and the type field indicates a categorization of the account to a higher category, e.g., “Expenses,” “Income,” and the like. The account name recommendation agent 206 can use any type of language processing technology to generate the recommended account name 208. Non-limiting examples of the language processing technology include large language models, deep learning models, machine learning models, generative artificial intelligence models, and/or any other type of language processing technology.

The account name recommendation agent 206 generates the recommended account name 208 without using the user's chart of accounts (CoA) database 224. That is, the account name recommendation agent 206 uses the language models to generate the recommended account name 208, while being agnostic to the existing account names. This independent generation of the recommended account name 208 allows for a flexibility to handle new types of accounts. For example, if a user does not have a payroll account to begin with and a new transaction comes in that the account name recommendation agent 206 determines is associated with payroll, the account name recommendation agent 206 generates a payroll account. This new account generation would not be possible if the account name recommendation agent 206 simply selected from the list of existing accounts.

However, once the recommended account name 208 is generated, a merge 210 is performed between the recommended account name 208 and existing accounts 220. The existing accounts 220 are retrieved from the user's chart of accounts database 224 using a retrieval operation 222. In one or more embodiments, the transaction 204 may be saved to the user's chart of accounts database 224 prior to generating the recommended account name 208. For instance, the transaction 204 may be saved as-is, without the recommended account name 208, for future retrieval, for comparison with other records in the user's chart of accounts database 22, and/or the like.

In one or more embodiments, the merge 210 includes appending the recommended account name 208 to the existing accounts 220 to generate merged accounts 212. As shown, the existing accounts 220 include ten accounts, id: “1” through id: “10.” In the illustrated example, the recommended account name 208 is appended to the fields and values as follows: id: “11”; name: “Gas”; type: “Expenses”. The merged accounts 212 therefore have eleven accounts from id: “1” through id: “11.”

A consolidation agent 216 is run on the merged accounts 212 to generate consolidated accounts 214. In one or more embodiments, the consolidation agent 216 combines account names, types, and/or other attributes to avoid redundancies, accounts with synonymous names, etc. As shown, the consolidation agent 216 has consolidated the two accounts: (1) id: “10”, name: “Fuel”, type: “Expenses” and (2) id: “11”, name: “Gas”, type: “Expenses” to a single account: id: “10”, name: “Fuel”, type: “Expenses”. The consolidation agent 206 may use any type of language processing technology for its operation. Non-limiting examples of the language processing technology include large language models, deep learning models, machine learning models, generative artificial intelligence models, and/or any other type of language processing technology. A chart of accounts update 236 is then performed to update the accounts database 224 with the consolidated accounts 214. The chart of accounts database 224 is therefore enhanced through the update 236.

A chart of accounts taxonomy agent 218 may be run to delineate the relationship 232 between the different accounts within the consolidated accounts 214. The chart of accounts taxonomy agent 218 may use any kind of language processing technology for its operation. Non-limiting examples of the language processing technology include large language models, deep learning models, machine learning models, generative artificial intelligence models, and/or any other type of language processing technology.

In the shown example, the chart of accounts taxonomy agent 218 delineates a hierarchical parent-child relationship within the consolidated accounts 214. Only one level of the hierarchical relationship 232 is shown for the sake of illustration and therefore this relationship should not be considered limiting. There may be multiple levels of hierarchical relationships. Two example parent-child relationships are presented in the shown hierarchical relationship 232. A first relationship is: parent: {id: 3, name: “Travels Meals and Drinks”, type: “Expenses}→child_id: {id: 1, name: “Employee Meals”, type: “Expenses”}. That is, “Employee Meals” is to be grouped under “Travel Meals and Drinks”. A second relationship is: parent: {id: 9, name: “Car and truck expenses”, type: “Expenses”}→child_id: {id: 10, name: “Fuel”, type: “Expenses”}. That is, “Fuel” is to be grouped under “Car and truck expenses”.

Therefore, three language models have been employed so far: (1) the account name recommendation agent 206 to recommend an account name, (2) the consolidation agent 216 to consolidate the recommended account name to the user's chart of accounts, and (3) the chart of accounts taxonomy agent 218 to delineate hierarchical relationship between the consolidated accounts. These language models execute in the background with minimal input from the user.

Additionally, another language model is used by an account name selection agent 226 to select an account name 228 for the incoming transactions data 202 (including the transaction 204). The account name selection agent 226 may use any kind of language processing technology for its operation. Non-limiting examples of the language processing technology include large language models, deep learning models, machine learning models, generative artificial intelligence models, and/or any other type of language processing technology.

In one or more embodiments, the account name selection agent 226 may select the account name for the transaction 204 from the user's chart of accounts database 224. For example, the account name selection agent 226 may select the account name from user's chart of accounts database 224 after the update 236. In contrast and as described above, the account name recommendation agent 206 does not access the user's chart of accounts database 224 for generating the recommended account name 208. Allowing the account name recommendation agent 206 to generate the recommended account name 208 independent of existing accounts in the accounts database 224 avoids the architecture 200 from greedily selecting from known account names. This flexibility allows the architecture 200 to accommodate new types of accounts, as described above.

A merge 230 is performed using the account name 228 and the relationship 232. The merge 230 provides the hierarchical relationship between the account name 228 and other accounts in the accounts database 224. A recommendation 234 is generated based on the merge 230. As shown, the recommendation 234 provides two hierarchically related account names from the transaction 204. In the shown example, a first account name “Fuel” is hierarchically below a second account name “Car and truck expenses”.

Using the aforementioned operations, the architecture 200 supports just-in-time complexity for transactions and account management. Should the recommended account name 208 be similar to the existing accounts 220, the consolidation agent 216 may consolidate the recommended account name 208 with one of the accounts in the existing accounts 220. Should the recommended account name 208 may be different from the existing accounts 220, the consolidation agent 216 may add the recommended account name 208 to the existing accounts 220 and update the accounts database 224. Additionally, the chart of accounts taxonomy agent 218 finds the hierarchical relationship between the accounts. Therefore, a new recommended account name 208 with any degree of relatedness to the existing accounts 220 may be handled by the architecture thereby maintaining or changing the existing level of complexity, as needed.

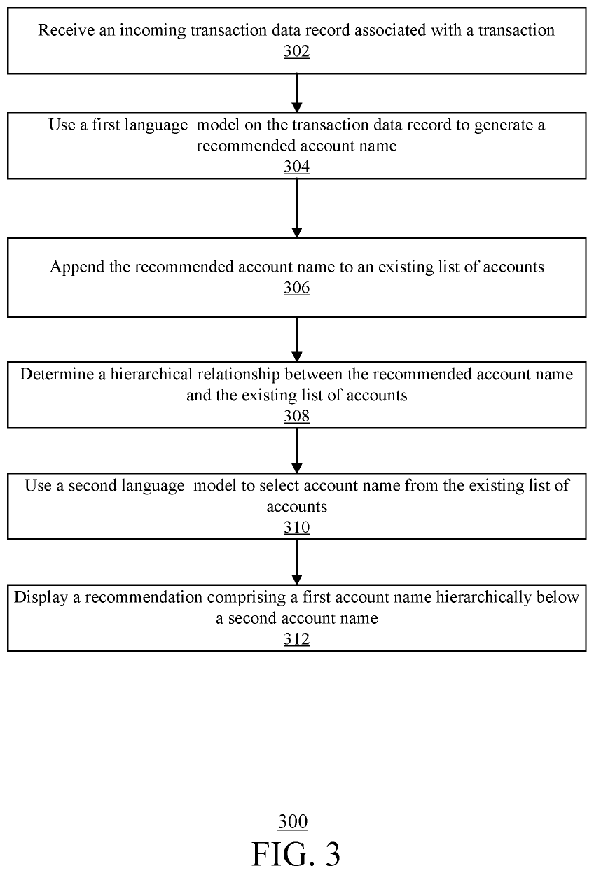

FIG. 3 shows a flow diagram of an example method 300 of automated account recommendations for a hierarchical account structure, based on the principles disclosed herein. It should, however, be understood that the steps of the method 300 are provided as examples and should not be considered limiting. Therefore, methods with alternative, additional, or fewer number of steps should be considered within the scope of this disclosure. The steps of the method 300 may be performed by any combination of components of the system 100 shown in FIG. 1 and the architecture shown in FIG. 2.

The method begins at step 302, where incoming transaction data associated with a transaction is received. The incoming transaction data includes a plurality of fields and a plurality of corresponding values. For example, the plurality of fields may include id, description, memo, posted_date, etc. The corresponding values provide specific instances for the fields, for example, posted_date can be “Nov. 30, 2022”.

At step 304, a first language model is used on the transaction data record to generate a recommended account name. The recommended account name is agnostic to the existing list of accounts. This type of recommendation therefore provides flexibility in determining new type of account names for new types of transaction data records.

At step 306, the recommended account name is appended to the existing list of accounts. The existing list of accounts is therefore updated with the appended account name, and the updated list is further consolidated to remove similar or synonymous accounts.

At step 308, a hierarchical relationship between the recommended account name and the existing list of accounts is generated. The hierarchical relationship reflects that some accounts may be grouped under another account with a broader coverage.

At step 310, a second language model is used to select an account name from an existing list of accounts. The existing list of accounts used by the second language model for account name selection may be the updated and consolidated list of accounts.

At step 312, a recommendation is displayed. The recommendation may include a first account name hierarchically below a second account name. For example, a first account name “Fuel” is hierarchically below a second account name “Car and truck expenses”.

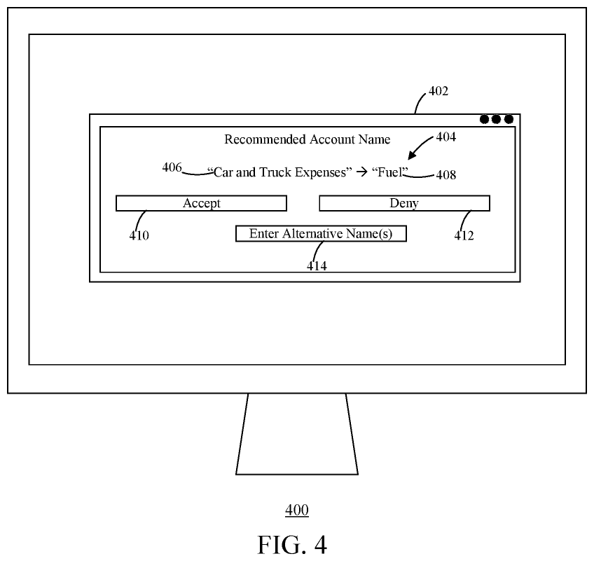

FIG. 4 shows an example graphical user interface (GUI) 400 displaying an account name recommendation, based on the principles disclosed herein. The GUI 400 can be presented by any part of the system 100 shown in FIG. 1. For instance, the GUI 400 can be presented by UIs 152 on the client devices 150. It should also be understood that the GUI 400 is just an example and therefore should not be considered limiting. That is GUIs with additional, alternative, or fewer number of displayed items should be considered within the scope of this disclosure.

As shown, the GUI 400 displays a window 402 providing a recommended account name 404. The recommended account name includes a first account name 406: “Fuel”, which is hierarchically below a second account name 408: “Car and Truck Expenses”. The GUI 400 also displays an accept option 410 to accept the recommended account name 404 and a deny option 412 to deny the recommended account name 404. Additionally, the GUI 400 displays an alternative name option 414 to allow the user to enter an alternative account name instead of the suggested account name 408.

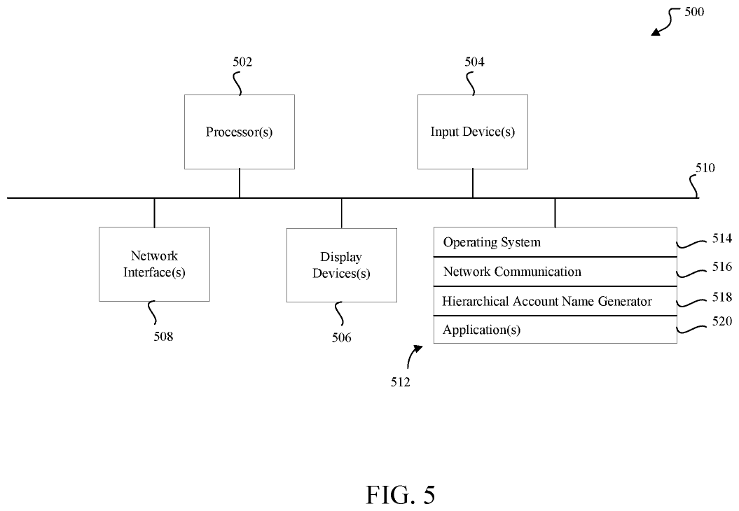

FIG. 5 shows a block diagram of an example computing device 500 that implements various features and processes based on the principles disclosed herein. For example, computing device 500 may function as first server 120, second server 130, client 150a, client 150b, or a portion or combination thereof in some embodiments. The computing device 500 may function as one or more portions of the architecture 200 and may perform one or more steps of the method 300. The computing device 500 may also display the GUI 400. The computing device 500 is implemented on any electronic device that runs software applications derived from compiled instructions, including without limitation personal computers, servers, smart phones, media players, electronic tablets, game consoles, email devices, etc. In one or more embodiments, the computing device 500 includes one or more processors 502, one or more input devices 504, one or more display devices 506, one or more network interfaces 508, and one or more computer-readable media 512. Each of these components is be coupled by a bus 510.

Display device 506 includes any display technology, including but not limited to display devices using Liquid Crystal Display (LCD) or Light Emitting Diode (LED) technology. Processor(s) 502 uses any processor technology, including but not limited to graphics processors and multi-core processors. Input device 504 includes any known input device technology, including but not limited to a keyboard (including a virtual keyboard), mouse, track ball, and touch-sensitive pad or display. Bus 510 includes any internal or external bus technology, including but not limited to ISA, EISA, PCI, PCI Express, USB, Serial ATA or FireWire. Computer-readable medium 512 includes any non-transitory computer readable medium that provides instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 512 includes various instructions 514 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 504; sending output to display device 506; keeping track of files and directories on computer-readable medium 512; controlling peripheral devices (e.g., disk drives, printers, etc.) which can be controlled directly or through an I/O controller; and managing traffic on bus 510. Network communications instructions 516 establish and maintain network connections (e.g., software for implementing communication protocols, such as TCP/IP, HTTP, Ethernet, telephony, etc.).

Hierarchical account name generator 518 includes instructions that implement the disclosed embodiments for determining and displaying hierarchical account names.

Application(s) 520 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer-implemented method comprising:
receiving an incoming transaction data record associated with a transaction, the transaction data record comprising a plurality of fields and a plurality of corresponding values;
using a first language model on the plurality of fields and the plurality of corresponding values to generate a recommended account name for the transaction;
appending the recommended account name to an existing list of accounts;
determining a hierarchical relationship between the recommended account name and the existing list of accounts;
using a second language model to select an account name for the transaction from the existing list of accounts; and
displaying through a graphical user interface a recommendation comprising a first account name hierarchically below a second account name based the selected account name, the existing list of accounts, and the hierarchical relationship.

2. The computer-implemented method of claim 1, the using of the first language model comprising:
using a large language model to generate the recommended account name for the transaction.

3. The computer-implemented method of claim 1, the using of the first language model comprising:
using a machine learning model or a deep learning model to generate the recommended account name for the transaction.

4. The computer-implemented method of claim 1, the using of the second language model comprising:
using a large language model to select the account name for the transaction from the existing list of accounts.

5. The computer-implemented method of claim 1, the using of the second language model comprising:
using a machine learning model or a deep learning model to select the account name for the transaction from the existing list of accounts.

6. The computer-implemented method of claim 1, the using of the first language model comprising:
using a large language model to generate the recommended account name for the transaction agnostic to the existing list of accounts.

7. The computer-implemented method of claim 1, further comprising:
after appending the recommended account name to the existing list of accounts, using a third language model to consolidate the existing list of accounts.

8. The computer-implemented method of claim 7, further comprising:
updating a chart of accounts database with the consolidated existing list of accounts.

9. The computer-implemented method of claim 8, the determining of the hierarchical relationship comprising:
using a fourth language model to the hierarchical relationship between the recommended account name and the existing list of accounts.

10. The computer-implemented method of claim 1, further comprising:
prior to using the first language model, storing the incoming transaction data record in a chart of accounts database.

11. A system comprising:
a non-transitory storage medium storing computer program instructions; and
one or more processors configured to execute the computer program instructions to cause the system to perform operations comprising:
receiving an incoming transaction data record associated with a transaction, the transaction data record comprising a plurality of fields and a plurality of corresponding values;
using a first language model on the plurality of fields and the plurality of corresponding values to generate a recommended account name for the transaction;
appending the recommended account name to an existing list of accounts;
determining a hierarchical relationship between the recommended account name and the existing list of accounts;
using a second language model to select an account name for the transaction from the existing list of accounts; and
displaying through a graphical user interface a recommendation comprising a first account name hierarchically below a second account name based the selected account name, the existing list of accounts, and the hierarchical relationship.

12. The system of claim 11, the using of the first language model comprising:
using a large language model to generate the recommended account name for the transaction.

13. The system of claim 11, the using of the first language model comprising:
using a machine learning model or a deep learning model to generate the recommended account name for the transaction.

14. The system of claim 11, the using of the second language model comprising:
using a large language model to select the account name for the transaction from the existing list of accounts.

15. The system of claim 11, the using of the second language model comprising:
using a machine learning model or a deep learning model to select the account name for the transaction from the existing list of accounts.

16. The system of claim 11, the using of the first language model comprising:
using a large language model to generate the recommended account name for the transaction agnostic to the existing list of accounts.

17. The system of claim 11, the operations further comprising:
after appending the recommended account name to the existing list of accounts, using a third language model to consolidate the existing list of accounts.

18. The system of claim 17, the operations further comprising:
updating a chart of accounts database with the consolidated existing list of accounts.

19. The system of claim 18, the determining of the hierarchical relationship comprising:
using a fourth language model to the hierarchical relationship between the recommended account name and the existing list of accounts.

20. The system of claim 11, the operations further comprising:
prior to using the first language model, storing the incoming transaction data record in a chart of accounts database.
